(19) United States
(12) Patent Application Publication
(10) Pub. No.: US 2018/0218375 A1
(43) Pub. Date: Aug. 2, 2018

(54) METHOD FOR CHECKING THE AUTHENTICITY OF THE INDICATION OF ORIGIN AND THE SHELF-LIFE SPECIFICATIONS OF PRODUCTS

(71) Applicants: Wolfgang BEYER, Leipzig (DE); Jürgen MISSING, Halle (DE)

(72) Inventors: Wolfgang BEYER, Leipzig (DE); Jürgen MISSING, Halle (DE)

(21) Appl. No.: 15/746,428

(22) PCT Filed: Jul. 1, 2016
(86) PCT No.: PCT/DE2016/000262

§ 371 Date: Jan. 22, 2018

(30) Foreign Application Priority Data
Jul. 20, 2015 (DE) 10 2015 009 123.9

(51) Int. Cl. G06Q 30/00; G06K 7/10; G06F 17/30

(52) U.S. Cl. CPC G06Q 30/018; G06F 17/30876; G06K 7/10722

(57) ABSTRACT

The invention relates to a method for checking the authenticity of the specifications of origin of products and the specifications of time-based guarantees of product properties. The method is used to combat product piracy and to provide the prerequisites for automated identification of products, the shelf-life of which is just before the predefined expiry thereof or the expiry of the time based functional guarantee thereof. The field of application extends in this case to checking food, pharmaceutical products through to technical products.

The invention relates to a method for checking the authenticity of the indications of origin of products and the information on time-related warranties of product properties. The procedure is designed to combat counterfeiting and to create the conditions for automated detection of products whose durability is nearing their predefined expiry date or expiration of their time-related functional warranty. The field of application extends to the control of foodstuffs, pharmaceutical products and technical products. It also creates the technical support conditions for proposed rebates on perishable products, which are timed within predefined time frames.

Previous anti-counterfeiting and anti-piracy solutions use visual trademarks or product engraving to authenticate the original products. Such visual marks can be designed, for example, as a hologram or laser engraving. After unpacking the article, the visual marks associated with the article undergo a close visual inspection. When the mark is applied to its labels or packaging, authentication is no longer possible after removal. Both solution variants can be imitated and are largely subject to the subjective assessment of authenticity. In order to eliminate these disadvantages, in particular for textile and leather goods, magnetic markings are introduced according to DE 601 22 293 T2 during production. These markers are invisible and remain present throughout the life of the article. For these markings amorphous ferromagnetic fibers are used, which are woven into the article or machine sewn. They are integrated into a textile label, a textile logo or a specific textile part of the article. A disadvantage of this solution, the existing imitation option by an identical production of the textile material with the magnetic markings. In addition, suitable devices are required separately for the acquisition of the measured values. They are integrated into a textile label, a textile logo or a specific textile part of the article. A disadvantage of this solution, the existing imitation option by an identical production of the textile material with the magnetic markings. In addition, suitable devices are required separately for the acquisition of the measured values. They are integrated into a textile label, a textile logo or a specific textile part of the article. A disadvantage of this solution, the existing imitation option by an identical production of the textile material with the magnetic markings. In addition, suitable devices are required separately for the acquisition of the measured values.

In order to reduce the effort for the production or incorporation of such markers or in terms of the cost of detecting the introduced security features, the method described in DE 10118679 A1 for the identification or authentication of products was created. Authentication means a statement of the existence of the original or a forgery. Identification refers to the ability to associate with a particular company, brand, location or production site, production line or batch, or production day. For this purpose, a ferromagnetic resonance active substance is used to mark the product or article mixed or combined with the product or article. Using a scanner, the ferromagnetic resonance is measured and based on the measured values authentication or identification is made. In addition, this solution allows for encryption by a predetermined code using different marker substances or different markers positioned, for example, on different, well-defined areas of an article. With the help of this code then further information about, for example, the place of origin can be encrypted. A disadvantage of this method, however, is the high cost of encryption by the attachment and measurements of the various marker substances at the different locations of the object. In addition, the individual mounting locations must be known for easy handling during acquisition. Also in this solution, especially suitable measuring devices are required for the detection of the marker substances.

According to WO 03/007252 A1, a method for authenticating products is described according to which a random code is assigned once to achieve the security against counterfeiting for each individual product. The code applied to the product itself or its packaging is capable of identifying a single product in a series of products. For example, the number code is printed on a label and the label is affixed to the packaging. At the same time, the manufacturer enters this code in a database accessible via the Internet. If the customer has purchased the product, he can enter the printed code over the Internet and compare it with the one in the database. As a result, it can be determined whether the code is identical to a code stored in the database and/or whether it has already been queried before. If the entered number code is not contained in the database, it is a plagiarism. If the code exists in the database, but has been retrieved by a third party before, you cannot reliably conclude that it is an original or a plagiarism. In this case, it could be the call by a middleman or the copy of the number code of a forger. There is also the possibility of the existence of the existing number code in the database if a copy of the product including the number has been made by the counterfeiter. Although there is then a plagiarism, the owner is left in the dark until the number of the original was retrieved.

In order to counteract these disadvantages, the solution for authenticating a product according to DE 20 2006 007 218 U1 proposes using an official banknote as data carrier for a specific code of the product. The official serial number assigned by the state central bank represents the code. A banknote accommodated in the packaging of the product or a detachable connection established between the banknote and the product only makes possible a one-time retrieval from the database created by the manufacturer. Otherwise, the presence of a forgery is signaled. A disadvantage of this solution, however, is the cost of providing the banknotes and the production costs for the additions or detachable Links. Furthermore, when used for a large number of products, there would be a significant withdrawal of banknotes from official money. In addition, resale after initial use would only be possible in conjunction with the associated banknote. Since a resale of the product usually results only after a prolonged use of the product, the banknote has in the majority of cases already been put back into circulation.

Also known is a solution for capturing and reproducing information by detecting areal and/or three-dimensional data elements that are applied to the surface of information carriers. In this system described in WO 2014/190961 A3 and the method used for operating the system for reproducing stored information, the values acquired from the geometric shapes and arrangements of the presentation elements are assigned to the information of further data or connections to services. In this case, codings are generated with the respective forms and arrangements of the presentation elements, from which data for the production of data-technological connections to databases via networks (Internet, Intranet) and/or to the addresses of mobile storage media are taken. In particular, this solution relates to the application in connection with the printing technology of the surfaces of substrates in data communication with modules of digital communication technology. In applying the anti-piracy system, there is a risk of counterfeiting of branded products by, in particular, two-dimensional counterfeiting by copying the indications of origin.

The object of the invention is therefore to provide a method for checking the authenticity of the indications of origin of products and their durability information, with the security of the detection of counterfeiting substantially increased, reduces the effort required for this and automated detection of the durability of products is possible. This object is achieved with the method characterized by the descriptive features of claim 1. Advantageous developments of the method according to the invention are described by the features claimed in claims 2 to 10 features. The procedure may optionally or simultaneously be used to control counterfeiting, authentication of products,

During the application of the indication of origin (e.g. brand), individual codes are preferably assigned to the design elements of the indication of origin and incorporated in material technology. In particular, for products of higher price classes, the introduction of these codes by engraving using laser technology within the design areas of indications of origin (brands). The storage of the individual product code used for comparison is carried out in conjunction with the assigned data of the origin marking and/or the data on the durability or time-related functional warranty as valid codes in a database. By capturing the design areas of the indications of source, the shelf life data of the original product are recorded at the same time as the individual product codes.

The method will be explained in more detail using an exemplary embodiment. In the drawing shows:

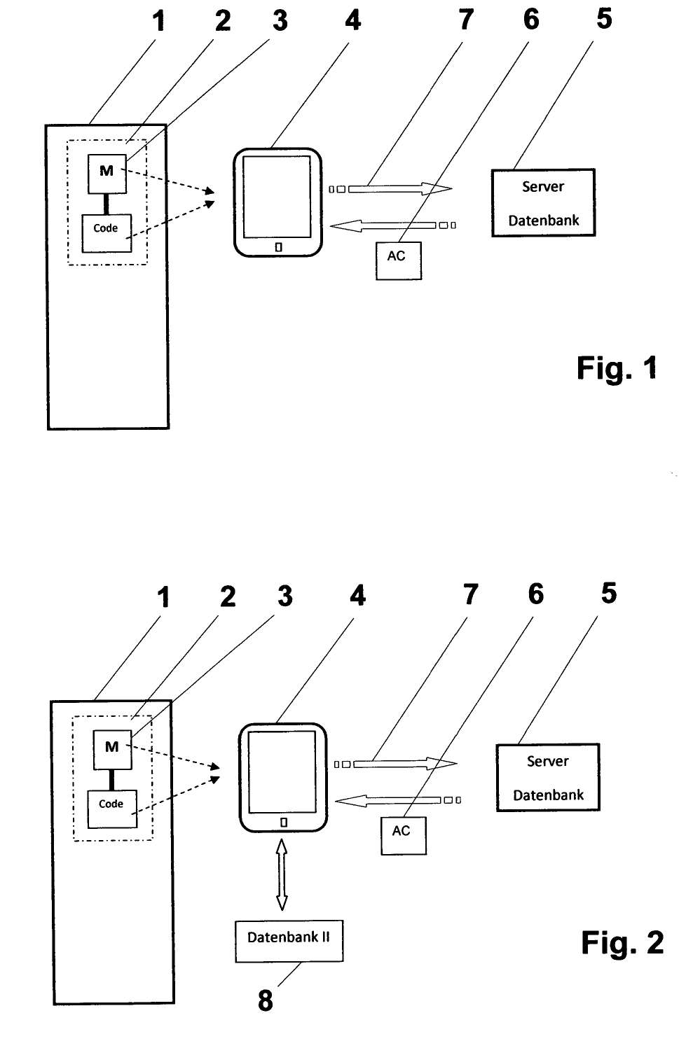

FIG. 1: the schematic sequence of the method for authenticity control of indications of origin; and

FIG. 2: the schematic sequence of the method in the control of the durability of perishable products.

With the schematic representation of FIG. 1, a variant of the authenticity control of indications of origin in conjunction with the data for authentication of the original product is reproduced. By assigning an individual code for each product 1, the application of counterfeit indications of origin (e.g. trademarks) on products is largely ruled out. The introduction of the individual code takes place on the part of the surface of the product 1, on which the mark 3 is applied. The application is carried out in such a way that no visible optical design features of the brand 3 are changed. By means of laser beam method, the code is incorporated encrypted by different wells. These depressions, which cannot be perceived by mere observation, can also be introduced on the design surface 2 of the mark 3. In particular, this technically more complex variant for high-priced products 1, such as watches with notoriously known brand names, suitable. Likewise, in a further variant of the introduction of individual coding pattern are applied to the area of origin markings. Such coding patterns consist of dot-shaped invisible color elements which are combined as a pattern containing the code. As suitable colors for example invisible IR colors can be used. Likewise, in a further variant of the introduction of individual coding pattern are applied to the area of origin markings. Such coding patterns consist of dot-shaped invisible color elements which are combined as a pattern containing the code. As suitable colors for example invisible IR colors can be used. Likewise, in a further variant of the introduction of individual coding pattern are applied to the area of origin markings. Such coding patterns consist of dot-shaped invisible color elements which are combined as a pattern containing the code. As suitable colors for example invisible IR colors can be used.

For the purpose of authentic control, the detection of the design elements by means of a mobile computing device 4, such as a smart phone, tablet PC, notebook, by triggering the “autofocus” function. The peripheral edges of the design surface 2 to be tested are detected. Thereafter, the optical representation elements of the total area between the peripherally delimiting edges are two-dimensionally picked up by the camera of the mobile computing device 4. For the purpose of discriminating the two-dimensional and three-dimensional code features introduced in the origin identifier, the camera is moved relative to the inspected surface during the detection process. During the usually upward movement, acquisitions from different distances (heights) and/or angles are performed by software. If different views of the visual display elements are detected due to the different incidence of light, a three-dimensional design feature is present within the design area 2. The changes in the optical views of three-dimensional representations upon detection from different planes or angles of incidence of the light may be enhanced by thereby triggering the flashlight device and/or the flashlight function. Alternatively, instead of the movement upwards, the camera can also be made laterally and thereby change the respective detection angle of the camera. With a required higher accuracy of the detection of the design features, the respective detection takes place within the different distance levels by the software-assisted connection of the ZOOM function of the camera. From the design elements of the acquired overall view, the connection data are decoded from the respective individual codes recorded, to connect to the server 5 of the manufacturer via the Internet 7. After the connection has been established, the individual code and the data of the detected brand 3 are transmitted. The values decoded by the server 5 are then compared with stored values of the data of the genuine product. If the comparison results in a match of the values, a corresponding signal is transmitted to the mobile computer device 4 and signaled by the latter visually and/or acoustically as a “genuine” product. In this case, a query code 6 is transmitted, which also contains the query time and the release for the querying seller. If the comparison yields deviations of the values, then the presence of a “counterfeit” product is signaled by the mobile computer device 4. After the connection has been established, the individual code and the data of the detected brand 3 are transmitted. The values decoded by the server 5 are then compared with stored values of the data of the genuine product. If the comparison results in a match of the values, a corresponding signal is transmitted to the mobile computer device 4 and signaled by the latter visually and/or acoustically as a “genuine” product. In this case, a query code 6 is transmitted, which also contains the query time and the release for the querying seller. If the comparison yields deviations of the values, then the presence of a “counterfeit” product is signaled by the mobile computer device 4. After the connection has been established, the individual code and the data of the detected brand 3 are transmitted. The values decoded by the server 5 are then compared with stored values of the data of the genuine product. If the comparison results in a match of the values, a corresponding signal is transmitted to the mobile computer device 4 and signaled by the latter visually and/or acoustically as a “genuine” product. In this case, a query code 6 is transmitted, which also contains the query time and the release for the querying seller. If the comparison yields deviations of the values, then the presence of a “counterfeit” product is signaled by the mobile computer device 4.

The database of the server 5 contains the assignments of the mark 3 to the individual codes of the products land a query code 6 associated therewith. The data of the mark 3 and of the individual code are compared with the data of the database and the associated interrogation code 6 is determined. If the respective data associated with the product 1 match, the authenticity of the product is signaled. For each query, the query code 6 is recreated according to a predetermined stored mathematical function. Subsequently, the new polling code 6 is sent from the server 5 to the polling mobile computing device 4. The server 5 registers the query and stores the time and the number of queries already made. For the authenticity check, in addition to the trademark data with the individual code, the valid query code 6 must also be entered and transmitted. Even with a complete imitation of the original product with individual code and brand data so the confirmation of the authenticity can be done only with simultaneous knowledge of the currently valid query code 6. When querying the database also more product information such as technical data, a three-dimensional audiovisual representation of the product is available.

During the recording process of the individual code, a hash function integrated into the evaluation software is used, which converts the acquired value. This conversion makes it impossible to trace back to the individual code of the product land thus significantly increases the security against counterfeiting. The converted value is sent to the server 5.

Within the server 5, the appropriate values of the product 1 to be checked are also converted and stored using the same hash function. After the transfer of the detected and hash function coded values, these are compared with the stored values. If the comparison results in a match of the values, a corresponding signal is transmitted to the mobile computer device 4 and signaled by the latter visually and/or acoustically as a “genuine” product of the manufacturer. If the comparison yields deviations of the values, then the presence of a “counterfeit” product 1 is signaled by the mobile computer device 4.

The data connection between the origin marking (e.g. brand) and the individual code can be designed as a hologram, in which, for example, the brand representation and the code are components of the hologram. Furthermore, instead of the laser engravings or holograms or in addition to these code patterns in the form of punctiform patterns are used, which are produced by dot-shaped applications of invisible dots of infrared color. These are detected by the camera sensor of the mobile computing device 4 and displayed on the display. The code is decrypted by creating a “template” on the code pattern by querying only predetermined polling points of the applied code pattern. In order to increase the detection accuracy and the required exclusive reproduction of the IR image (pattern), an IR filter is arranged between the camera sensor and the code pattern to be detected, which hides the influence of daylight. The key for the respective locations of the code pattern to be queried is stored in the database and is sent to the mobile computing device 4 at the query from the data associations of the brand and individual connection code. This determines the values of the code pattern at the locations specified by the key and sends them to the database. After comparing the code thus decrypted, a comparison is then made with the valid stored values.

The schematic representation of FIG. 2 shows the procedural sequence of the process in the authenticity control and detection of the shelf life of perishable products such as food and pharmaceutical products as well as the time-related Functional guarantee of technical products. In this variant of the use of the method, the individual code is combined with the data of the indication of origin and the expiry date and this data is applied to the product 1 itself or the packaging. The code with the expiry date is printed on the surface of the product 1 or the packaging. For this purpose, in addition to or on the visible design features of the origin marking (trademark), the individual code is generated as a dot-shaped code combination by means of color dots of invisible IR color. The data of the code combination are then stored in the database II. At each over the Internet or the connection to a mobile data storage taking place query the stored data of the respective genuine product, a new query code 6 is generated. In addition to the code data, this also contains the date of the query and the number of queries already made. With this query code 6 ensures that only the interrogator can make a new query to the existing authenticity of the product 1, which is also in the possession of the respective valid query code 6. The individual security code serves to identify the respective originality or uniqueness of the product land the interrogation code 6 to prevent undiscovered imitations,

The storage of the shelf life data in a query carried out in another database 8 allows the overview and timely signaling of those products 1, for which a price discount is provided within predetermined periods.

1. A method for checking the authenticity of the indications of origin of products and their time-related guarantee of product properties, characterized in that:
(a) the indication of origin is applied to the product (1) in data communication with an individual security code,
b) in the authenticity control the optical design features within the design surface (2) are detected in their entirety by means of a computer device,
c) a decoding of the connection data contained in the individual security code to a database, which contains the respective individual security code, the data of the origin identifier and a query code (6) associated therewith, by the computer device,
d) after the connection to the database, a comparison of the transmitted data with the data stored in the database is done and each query a new query code (6) is created and sent to the computer device, and
e) is sent at a detected agreement of the values of the new query code (6) as a signal for authenticity to the computer device and a deviation of the compared values, a signal for the presence of a forgery is sent to the computer device and the transmitted signals from this optical and/or acoustically reproduced.

2. The method according to claim 1, characterized in that the data-technical connection of the origin marking with the individual security code by coding by means of a three-dimensional material technology incorporation during the process engineering application of the origin marking on the product (1).

3. The method according to claim 1, characterized in that the data-technical connection of the origin marking with the data on the time-related warranty of product properties within the printing design of the indication of origin during their application to the product (1).

4. The method according to claim 1, characterized in that the data connection of the origin marking is produced via a connection code to further product information and/or to a three-dimensional optical representation of the marked product (1).

5. The method according to claim 1, characterized in that the origin marking and the data technically associated with this individual security code and/or information about the warranty period of the product properties of the camera of a mobile computer device (4) is detected by means of autofocus in the entirety, a data assignment the comparison values stored in a database and corresponding to the encrypted data are compared with each other and the optically and/or acoustically signaled by the mobile computer device (4) after the coded signal transmission and the retrieval of the comparative data of the integrated data association of the genuine origin labeling from the database becomes.

6. A method according to claim 1, characterized in that the camera-technological detection of the origin marking during each detection process takes place alternately during the exposure by means of the flash device of the mobile computing device (4) and without exposure to the Blit breeding equipment.

7. Method according to claims 1 and 6, characterized in that the camera-technological detection of the origin marking during a detection process takes place alternately under at least two different predetermined light incidence angles and with the inclusion of the “ZOOM” function.

8. The method according to claim 1, characterized in that assigned during the printing manufacturing process for each of the products an individual coding pattern in the form of a predetermined number of different arrangements of printing visible and/or invisible design elements and applied to the surface of the origin mark and stored in a database, when verifying authenticity, the coding patterns are detected according to an encrypted specification of the elements of the coding pattern to be checked, and then compared with the values of the values stored in the database.

9. The method according to claims 1 and 8, characterized in that the control of the data for time-related warranty of the product properties by means of a comparison of the coded in the coding expiration date with the in the database the product (1) associated with the expiration date.

10. The method according to claim 1, characterized in that the detected individual coding of the respective product (1) converted by means of a hash function, sent to the server (5) and stored by the server (5) with the also converted by means of the hash function stored Values of the genuine product (I).
